(19) United States
(12) Patent Application Publication
(10) Pub. No.: US 2014/0119084 A1
(43) Pub. Date: May 1, 2014

(54) AC Input Voltage Detection Circuit and AC/DC Power Source

(71) Applicant: Sanken Electric Co., LTD., Niiza-shi (JP)

(72) Inventor: Toru Ashikaga, Niiza-shi (JP)

(73) Assignee: SANKEN ELECTRIC CO., LTD., Niiza-shi (JP)

(21) Appl. No.: 14/037,442

(22) Filed: Sep. 26, 2013

(30) Foreign Application Priority Data
Oct. 31, 2012 (JP) 2012-240297

(51) Int. Cl. H02M 7/06

(52) U.S. Cl. CPC H02M 7/066
USPC 363/126

(57) ABSTRACT

An AC input voltage detection circuit of detecting abnormality of an AC input voltage inputted to an AC/DC converter, includes: a first comparator circuit configured to compare the AC input voltage with a first reference voltage; a second comparator circuit configured to compare the AC detection voltage with a second reference voltage higher than the first reference voltage; and a timer circuit configured to start counting of a timer if the first comparator circuit detects that the AC input voltage is equal to or lower than the first reference voltage and to clear the counting of the timer if the second comparator detects that the AC input voltage is larger than the second reference voltage, wherein the timer circuit outputs an AC abnormality detection signal when a preset abnormality detection time is passed without clearing the counting since the counting of the timer has been started.

### CROSS-REFERENCE T0 RELATED APPLICATION

This application claims priority from Japanese Patent Application No. 2012-240297 filed on Oct. 31, 2012, the entire subject matter of which is incorporated herein by reference.

### TECHNICAL FIELD

This disclosure relates to an AC input voltage detection circuit of detecting abnormality of an AC input voltage, and an AC/DC power source.

### BACKGROUND

As shown in FIG. 6A, an AC/DC power source, which rectifies and smoothens an AC input voltage inputted from an alternating current power source AC to output a desired DC voltage, is used to supply a DC voltage to a load shown as a host (CPU, a memory or the like), such as a server. A holding time, which is determined by an electrolytic capacitor or the like, is set in the AC/DC power source. The holding time is a time period for ensuring that a power-supply device can supply a stable DC voltage to a load, and is one of specification items of the power-supply devices. When the alternating current power source AC is interrupted, the AC/DC power source is continuously operated until the holding time is passed over, but operation thereof is stopped after the holding time has been passed. Therefore, in a case where the host is a server dealing with important data, an arcade game machine or the like, a termination process such as data saving has to be performed during a period from the interruption of the alternating current power source AC to the end (operation stop) of the holding time of the AC/DC power source. Therefore, when the alternating current power source AC is interrupted, an AC abnormality detection signal for notifying abnormality to the host is outputted from the AC/DC power source (e.g., see JP H11-155284 A).

Generally, the holding time of the AC/DC power source is mostly few tens ms. During such a short period of time, the AC/DC power source has to output the AC abnormality detection signal to the host, and the host has to perform the termination process as a system according to the AC abnormality detection signal. For example, as shown in FIG. 6B, it is assumed that the holding time T1 of the AC/DC power source is 20 ms, and a termination process time T2 according to the termination process of the host is 8 ms. In this case, if the AC abnormality detection signal can be outputted within 12 ms from occurrence of the power interruption, it is calculated that the host can safely complete the termination process. Accordingly, 12 ms from occurrence of the power interruption of the alternating current power source AC has to be accurately measured. However, when the AC abnormality detection signal is outputted at 13 ms after occurrence of the power interruption, a time period available for the termination process of the host is only 7 ms, and thus the termination process cannot be completed. In other words, an accurate time measurement is required to generate the AC abnormality detection signal. Further, the same signal process may be required even in a case of a low voltage beyond a power supply operation specification range, as well as a power interruption, an accurate time measurement is required with respect to both of a power interruption and a low voltage.

Referring to FIG. 7, an AC input voltage detection circuit 4 for outputting an AC abnormality detection signal according to the background art includes resistors R1, R2, R3, a diode D, a comparator 41, a reference voltage Vs, and a timer unit 42.

The resistor R1, the diode D and the resistor R3 are connected in series between an AC input terminal ACin1 of a rectifier circuit DB and a grounding terminal. Also, the resistor R2 having the same resistance value as that of the resistor R1 is connected between an AC input terminal ACin2 of the rectifier circuit DB and a connection point between the resistor R1 and an anode of the diode D. Thus, a voltage detected at a connection point between the resistor R3 and a cathode of the diode D has a waveform obtained by full-wave-rectifying both phases of the AC input voltage. Hereinafter, the voltage detected at the connection point between the resistor R3 and the cathode of the diode D is referred to as an AC detection voltage. Hereinafter, the voltage detected at the connection point between the resistor R3 and the cathode of the diode D is referred to as an AC detection voltage.

The connection point between the resistor R3 and the cathode of the diode D is connected to an inverted input terminal of the comparator 41, and the reference voltage Vs is connected to a non-inverted input terminal of the comparator 41. Therefore, an output of the comparator 41 becomes Low level if the AC detection voltage is higher than the reference voltage Vs, and the output of the comparator 41 becomes High level if the AC detection voltage is equal to or lower than the reference voltage Vs.

As shown in FIG. 8, the timer unit 42 starts counting of a tinier at a timing of times t11 and t13, at which the output of the comparator 41 is risen, i.e. the output is inverted to the High level, and clears the counting of the tarter at a timing of a time t12, at which the output of the comparator 41 is fallen, i.e. the output is inverted to the Low level. In this case, if the alternating current power source AC is interrupted at a time tc, the AC detection voltage thereafter becomes 0 volt. Thus, since the AC detection voltage does not become a voltage higher than the reference value Vs, the counting value of the timer is not cleared. Then, at a time t14 after the abnormality detection time T0 has been passed from the time t13, the AC abnormality detection signal is outputted.

Here, a time period from tc to t13 is an error tune. The AC input voltage is a sine wave, and therefore has a moment, at which the AC input voltage crosses 0 volt. During this moment, it cannot be determined whether the alternating current power source AC is interrupted or normal, and thus the error time is inevitably occurred. In order to reduce the error time as small as possible, the reference voltage Vs has to be set as low as possible.

### SUMMARY

However, according to the background art, when a power interruption and a low voltage are detected as abnormality of the alternating current power source AC to output the AC abnormality detection signal, there is a problem in that a time, at which the AC input voltage becomes abnormal, cannot accurately measured, and thus the AC abnormality detection signal cannot be outputted at a desired timing.

In other words, as shown in FIG. 9, when the reference voltage Vs is set to a value of around 0 volt to detect a power interruption as abnormality of the alternating current power source AC, the AC detection voltage at a time t15 is higher than the reference voltage Vs even if a low voltage is occurred at the time tc, and as a result, the counting of the timer is cleared at a timing, at which the output of the comparator 41 is fallen, i.e. the output is inverted to the Low level. Therefore, when a low voltage is occurred in the alternating current power source AC, the time, at which the AC input voltage becomes abnormal, cannot be accurately measured, and thus the AC abnormality detection signal cannot be outputted.

In addition, as shown in FIG. 10, when the reference voltage Vs is set to a higher value to detect a low voltage as abnormality of the alternating current power source AC, the AC detection voltage is lower than the reference voltage Vs even at a peak value in the abnormal state, so that the output of the comparator 41 is not inverted. Therefore, the AC abnormality detection signal is outputted at a time t24 after the abnormality detection time T0 has been passed from a time t23, at which counting of the timer is started. However, the time t23, at which counting of the timer is started, is prior to the time tc, at which a low voltage of the alternating current power source AC is occurred. Therefore, the time, at which the AC input voltage becomes abnormal, cannot be accurately measured, and thus the AC abnormality detection signal is outputted in a time shorter than a predetermined time.

In view of the above, this disclosure provides at least an AC input voltage detection circuit and an AC/DC power source, in which a time, at which an AC input voltage becomes abnormal, can be accurately measured even if abnormality occurred in an alternating current power source AC is caused by either of a power interruption or a low voltage.

An AC input voltage detection circuit of this disclosure to detect abnormality of an AC input voltage inputted to an AC/DC converter, comprises: a first comparator circuit configured to compare the AC input voltage with a first reference voltage; a second comparator circuit configured to compare the AC detection voltage with a second reference voltage higher than the first reference voltage; and a timer circuit configured to start counting of a timer if the first comparator circuit detects that the AC input voltage is equal to or lower than the first reference voltage and to clear the counting of the timer if the second comparator detects that the AC input voltage is larger than the second reference voltage, wherein the timer circuit outputs an AC abnormality detection signal when a preset abnormality detection time is passed without clearing the counting since the counting of the timer has been started.

In the above-described AC input voltage detection circuit, the first reference voltage may be set to be equal to or lower than a peak value of a low voltage, which is detected as abnormality, and the second reference voltage may be set to be larger than the peak value of the low voltage, which is detected as abnormality.

In the above-described AC input voltage detection circuit, the first reference voltage may be a threshold voltage for detecting whether the AC input voltage is interrupted or not, and the second reference voltage may be a threshold voltage for detecting whether the AC input voltage is a low voltage or not.

In the above-described AC input voltage detection circuit, the abnormality detection time is set to a time period shorter than a time obtained by subtracting a termination process time in a load, to which the AC/DC converter supplies a DC voltage, from a holding time of the AC/DC converter.

In another aspect of this disclosure, an AC/DC power source comprising AC input voltage detection circuit of detecting abnormality of an AC input voltage inputted to an AC/DC converter, the AC input voltage detection circuit comprises: a first comparator circuit configured to compare the AC input voltage with a first reference voltage; a second comparator circuit configured to compare the AC detection voltage with a second reference voltage higher than the first reference voltage; and a timer circuit configured to start counting of a timer if the first comparator circuit detects that the AC input voltage is equal to or lower than the first reference voltage and to clear the counting of the timer if the second comparator detects that the AC input voltage is larger than the second reference voltage, wherein the timer circuit outputs an AC abnormality detection signal when a preset abnormality detection time is passed without clearing the counting since the counting of the timer has been started.

According to this disclosure, the effect can be achieved that even if abnormality occurred in the AC input voltage is either of a power interruption or a low voltage, counting of the timer can be started based on the first reference voltage lower than the second reference voltage, the time, at which the AC input voltage becomes abnormal, can be accurately measured.

### BRIEF DESCRIPTION OF THE DRAWINGS

The foregoing and additional features and characteristics of this disclosure will become more apparent from the following detailed descriptions considered with the reference to the accompanying drawings, wherein:

FIG. 1 is a configuration view illustrating a circuit configuration of an embodiment of an AC input voltage detection circuit according to this disclosure;

FIG. 2 is a waveform diagram illustrating signal waveforms and operation waveforms of each unit in FIG. 1 when an interruption is occurred in an alternating current power;

FIG. 3 is a waveform diagram illustrating signal waveforms and operation waveforms of each unit in FIG. 1 when a low voltage is occurred in the alternating current power;

FIG. 4 is a configuration view illustrating a circuit configuration of an embodiment of an AC/DC power source according to this disclosure;

FIG. 5A and 5B are waveform diagrams illustrating a DC voltage of the AC/DC power source shown in FIG. 4;

FIG. 6A and 6B are an explanatory view for explaining an output timing of an AC abnormality detection signal;

FIG. 7 is a configuration view illustrating a circuit configuration of at AC input voltage detection circuit according to the background art;

FIG. 8 is a waveform diagram illustrating signal waveforms and operation waveforms of each unit in FIG. 7 when an interruption is occurred in an alternating current power according to the background art;

FIG. 9 is a waveform diagram illustrating signal waveforms and operation waveforms of each unit in FIG. 7 when a low voltage is occurred in the alternating current power according to the background art; and

FIG. 10 is a waveform diagram illustrating signal waveforms and operation waveforms of each unit in FIG. 7 when a low voltage is occurred in the alternating current power according to the background art.

### DETAILED DESCRIPTION

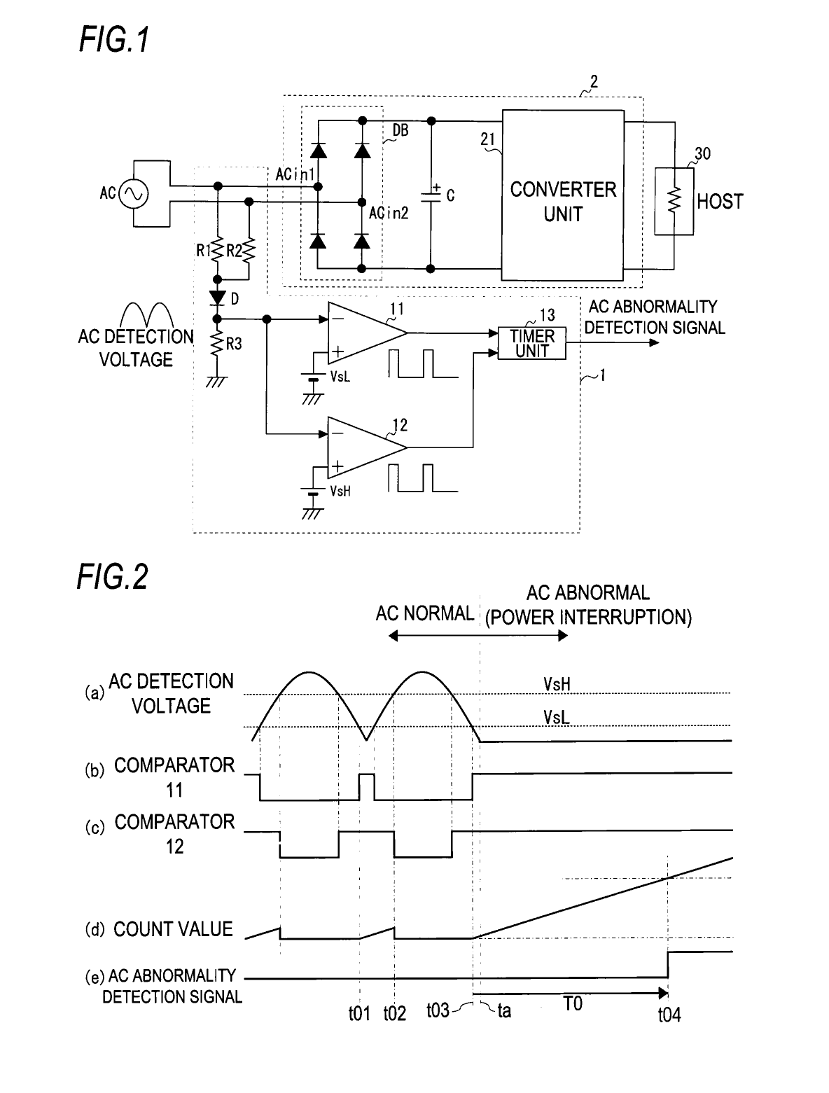

An AC input voltage detection circuit 1 according to the present embodiment is a circuit of detecting an interruption or a low voltage of an alternating current power inputted in an AC/DC converter 2. Referring to FIG. 1, the AC/DC converter 2 includes a rectifier circuit DB, an electrolytic capacitor C and a converter unit 21, and supplies a DC voltage to a load shown as a host 30, such as a sever.

In the AC/DC converter 2, an alternating current power source AC is connected to AC input terminals ACin1 and ACin2 of the rectifier circuit DB, in which a diode is bridged, and an AC input voltage inputted from the alternating current power source AC is full-wave-rectified by and outputted from the rectifier circuit DB. The electrolytic capacitor C is connected between a rectified output positive terminal and a rectified output negative terminal of the rectifier circuit DB. Thus, a rectified and smoothed DC voltage can be obtained from the voltage of the alternating current power source AC by the rectifier circuit DB and the electrolytic capacitor C.

The converter unit 21 is a circuit of converting the DC voltage, which is rectified and smoothed by the rectifier circuit DB and the electrolytic capacitor C, to a desired DC voltage, and can employ a switching power supply, a dropper power supply, or the like and combinations thereof. Alternatively, the converter unit 21 may be omitted, and the DC voltage rectified and smoothed by the rectifier circuit DB and the electrolytic capacitor C may be directly supplied to the load 30.

Referring to FIG. 1, the AC input voltage detection circuit 1 includes resistors R1, R2 and R3, a diode D, comparators 11 and 12, reference voltages VsL and VsH, and a timer unit 13.

The diode D and the resistor R3 are connected in series between the AC input terminal ACin1 of the rectifier circuit DB and a grounding terminal, the resistor R1. Also, the resistor R2 having the same resistance value as that of the resistor R1 is connected between the AC input terminal ACin2 of the rectifier circuit DB and a connection point between the resistor R1 and an anode of the diode D. Thus, a voltage detected at a connection point between the resistor R3 and a cathode of the diode D has a waveform obtained by full-wave-rectifying both phases of the AC input voltage. Hereinafter, the voltage detected at the connection point between the resistor R3 and the cathode of the diode D is referred to as an AC detection voltage.

The connection point between the resistor R3 and the cathode of the diode D is connected to an inverted input terminal of the comparator 11 and the reference voltage VsL is connected to a non-inverted input terminal of the comparator 11. Therefore, an output of the comparator 11 becomes Low level if the AC detection voltage is higher than the reference voltage VsL, and the output of the comparator 41 becomes High level if the AC detection voltage is al to or lower than the reference voltage VsL.

Also, the connection point between the resistor R3 and the cathode of the diode D is connected to an inverted input terminal of the comparator 12, and the reference voltage VsH is connected to a non-inverted input terminal of the comparator 12. Therefore, an output of the comparator 12 becomes Low level if the AC detection voltage is higher than the reference voltage VsH, and the output of the comparator 12 becomes High level if the AC detection voltage is equal to or lower than the reference voltage VsH.

The reference voltage VsL is a threshold voltage for determining whether the AC input voltage is interrupted or not. Therefore, the reference voltage VsL is set to be equal to or lower than a peak value (a value of divided voltage) of a low voltage, which is detected as abnormality, and thus to be a value of around 0 volt. If the output of the comparator 11 is High level, this means one of the following: a case where the AC input voltage is interrupted and thus 0 volt, and a case where the AC input voltage is pulsated and also is around 0 volt. In other words, the AC input voltage is a sine wave, and therefore has surely a moment, at which the AC input voltage crosses 0 volt. In. this moment, it cannot be determined whether the AC input voltage is ‘abnormal (a power interruption)’ or ‘normal’. If the AC input voltage is ‘normal’, the AC detection voltage is increased immediately thereafter, and thus the output of the comparator 11 is inverted to the Low level. Contrarily, if the AC input voltage is ‘abnormal (a power interruption)’, the AC detection voltage does not exceed the threshold voltage, and thus the output of the comparator 11 is remained as the High level.

The reference voltage VsH is a threshold voltage for determining whether the AC input voltage is a low voltage or not, and therefore, is set to be higher than the reference voltage VsL and also to a value larger than the peak value of the low voltage, which is detected as abnormality, The reference voltage VsH is appropriately set according to a level of the low voltage to be detected. If the output of the comparator 12 is High level, this means one of the following: a case where the AC input voltage is a low voltage equal to or lower than a predetermined voltage, and a case where the AC input voltage is pulsated and also becomes equal to or lower than the predetermined voltage. In other words, the AC input voltage is a sine wave, and therefore has surely a period, during which the AC input voltage is equal to or lower than the predetermined voltage. In this period, it cannot be determined whether the AC input voltage is ‘abnormal (a low voltage)’ or ‘normal’. If the AC input voltage is ‘normal’, the AC detection voltage becomes higher than the predetermined voltage immediately thereafter, and thus the output of the comparator 12 is inverted to the Low level. Contrarily, if the AC input voltage is ‘abnormal (a low voltage)’, the AC detection voltage does not become a voltage higher than the predetermined voltage, and thus the output of the comparator 12 is remained as the High level.

The timer unit 13 starts counting of a timer at a timing, at which he output of the comparator 11 is risen, i.e. the output is inverted to the High level, and outputs an AC abnormality detection signal if the counting valve reaches a preset abnormality detection time T0. The AC abnormality detection signal is a signal for previously notifying ‘abnormality (the end of a holding time due to a power interruption or a low voltage)’ to the host 30, such as a server, to which the AC/DC converter 2 supplies the DC voltage, Thus, the abnormality detection time T0 is set to a time period slightly shorter than a value which is obtained by subtracting a termination process time T2 for data saving in the host 30 or the like from the holding time T11 of the AC/DC converter 2 after the alternating current power source AC is interrupted. Also, in a case of an instantaneous power interruption of the extent that the operation of the AC/DC converter 2 is not affected, it is preferable that the AC abnormality detection signal is not outputted if possible. Therefore, the abnormality detection time T0 is set to a time period as long as possible in the condition as described above. Thus, the occurrence timing of ‘abnormality (a power interruption or a low voltage)’ of the AC input voltage has to be time-measured at a high accuracy.

Further, the timer unit 13 clears the counting of the timer at a timing at which the output of the comparator 12 is fallen, i.e. the output is inverted to the Low level. Thus, if the AC input voltage is ‘normal’, the counting is cleared prior to the abnormality detection time T0, and the AC abnormality detection signal is not outputted. In addition, as a counter of the timer in the timer unit 13, a microcomputer, a time constant of a CR circuit or the like can be employed.

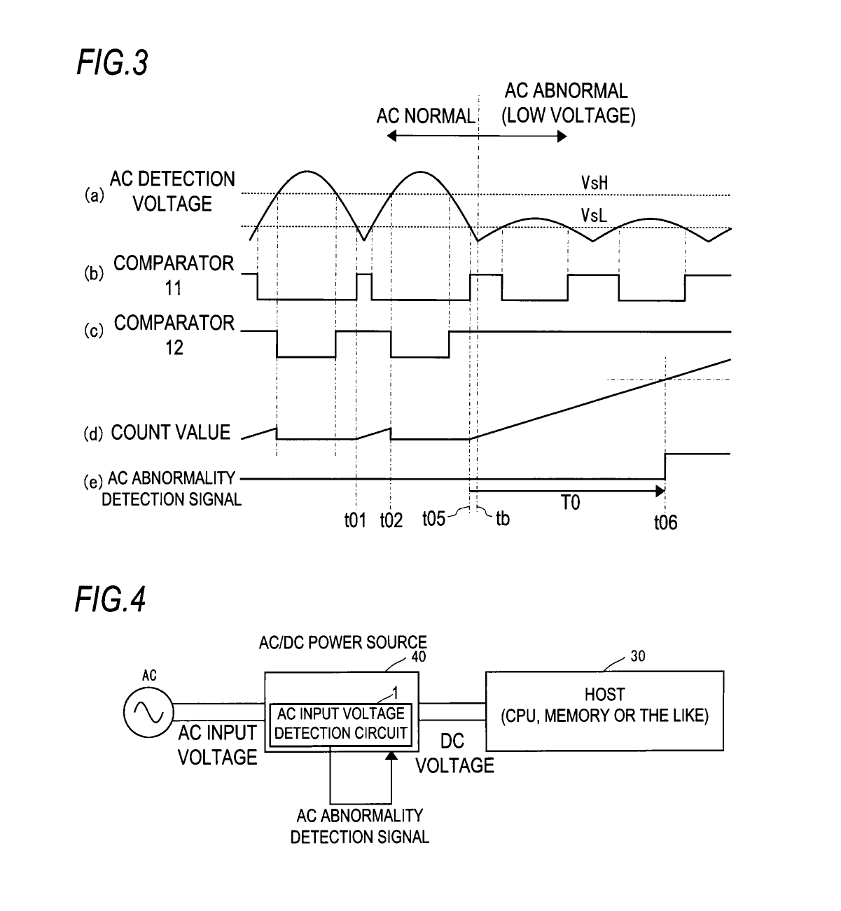

FIGS. 2 and 3 are timing charts illustrating a signal of each unit of the AC input voltage detection circuit 1 shown in FIG. 1, where time chart (a) indicates the AC detection voltage, time chart (b) indicates the output signal of the comparator 11, time chart (c) indicates the output signal of the comparator 12, time chart (d) indicates the counting value of the timer, and time chart (e) indicates the AC abnormality detection signal.

In FIG. 2, signal waveforms of the signal of each unit when the AC input voltage becomes ‘abnormal (a power interruption)’ at a time ta is shown.

If the AC input voltage is ‘normal’, the counting value of the timer started at a timing of a time t01, at which the AC detection voltage becomes equal to or lower than the reference voltage VsL and the output of the comparator 11 is inverted to the High level, is cleared at a timing of a time t02, at which the AC detection voltage becomes higher than the VsH and the output of the comparator 12, is inverted to the Low level. Since the abnormality detection time T0 is rightly set to a time period longer than a time period from the time t02 to the time t01, if the AC input voltage is ‘normal’, the AC abnormality detection signal is not outputted. In addition, although clearing of the counting value of the timer is performed due to fallen of the output of the comparator 12 based on the reference voltage VsH as a threshold value, the clearing means a case where ‘abnormality (a power interruption or a low voltage)’ is not occurred, and thus a time accuracy of the AC abnormality detection signal is not affected.

If the AC input voltage becomes ‘abnormal (a power interruption) at a time ta, counting of the timer is started at a timing of time t03 just before the AC detection voltage becomes equal to or lower than the reference value VsL and the output of the comparator 11 is inverted to the High level. Thereafter, since the AC input voltage is ‘abnormal (a power interruption) and thus the AC detection voltage does not become a voltage higher than the reference value VsH, the counting value of the timer is not cleared. Then, at a time tO4 after the abnormality detection time T0 has been passed from the time t03, the AC abnormality detection signal is outputted. In this way, the counting of the timer is performed due to the risen of the output of the comparator based on the reference voltage VsL as a threshold value at a timing just before the time ta, at which the AC input voltage becomes ‘abnormal (a power interruption). Thus, the occurrence timing of ‘abnormality (a power interruption)’ of the AC input voltage can be time-measured at a high accuracy.

In FIG. 3, a signal waveform of the signal of each unit when the AC input voltage becomes ‘abnormal (a low voltage)’ at a time tb is shown.

If the AC input voltage becomes ‘abnormal (a low voltage) at a time tb, counting of the timer is started at a timing of a time t05 just before the AC detection voltage becomes equal to or lower than the reference value VsL and the output of the comparator 11 is inverted to the High level. Thereafter, since the AC input voltage is ‘abnormal (a low voltage) and thus the AC detection voltage does not become a voltage higher than the reference value VsH, the counting value of the timer is not cleared. Then, at a time t06 after the abnormality detection time T0 has been passed from the time t05, the AC abnormality detection signal is outputted. In this way, the counting of the timer is performed due to the risen of the output of the comparator 11 based on the reference voltage VsL as a threshold value at a timing just before the time tb, at which the AC input voltage becomes ‘abnormal (a low voltage). Thus, the occurrence timing of ‘abnormality (a low voltage)’ of the AC input voltage can be also time-measured at a high accuracy.

In addition, as shown in FIG. 4, an AC/DC power source 40 having the AC input voltage detection circuit 1 may be configured such that the AC/DC power source 40 itself uses the AC abnormality detection signal outputted form the AC input voltage detection circuit 1.

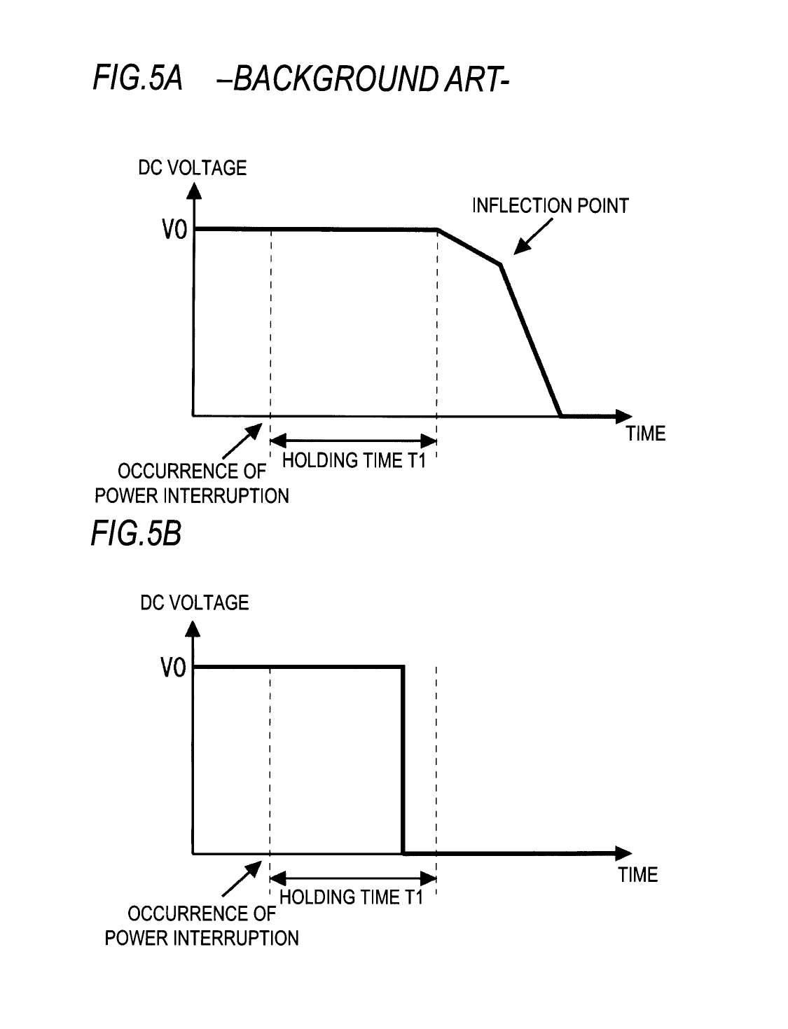

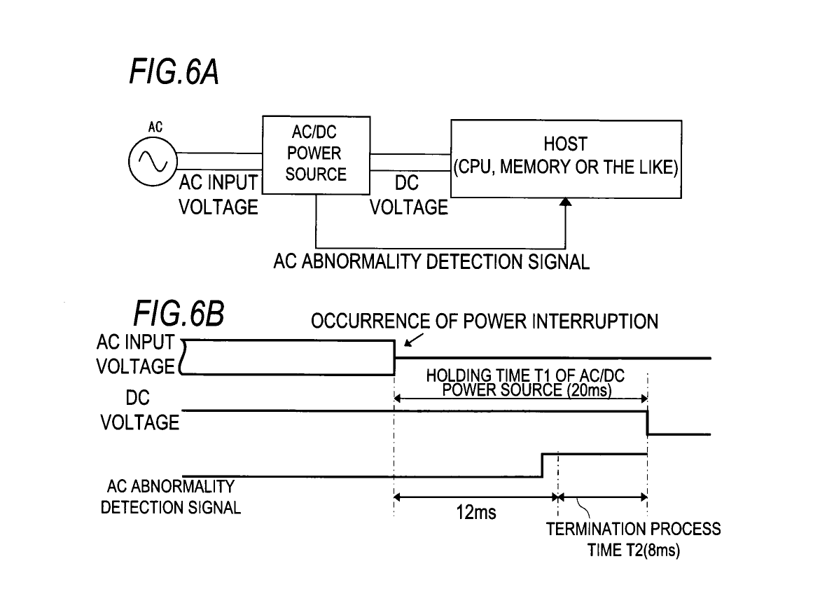

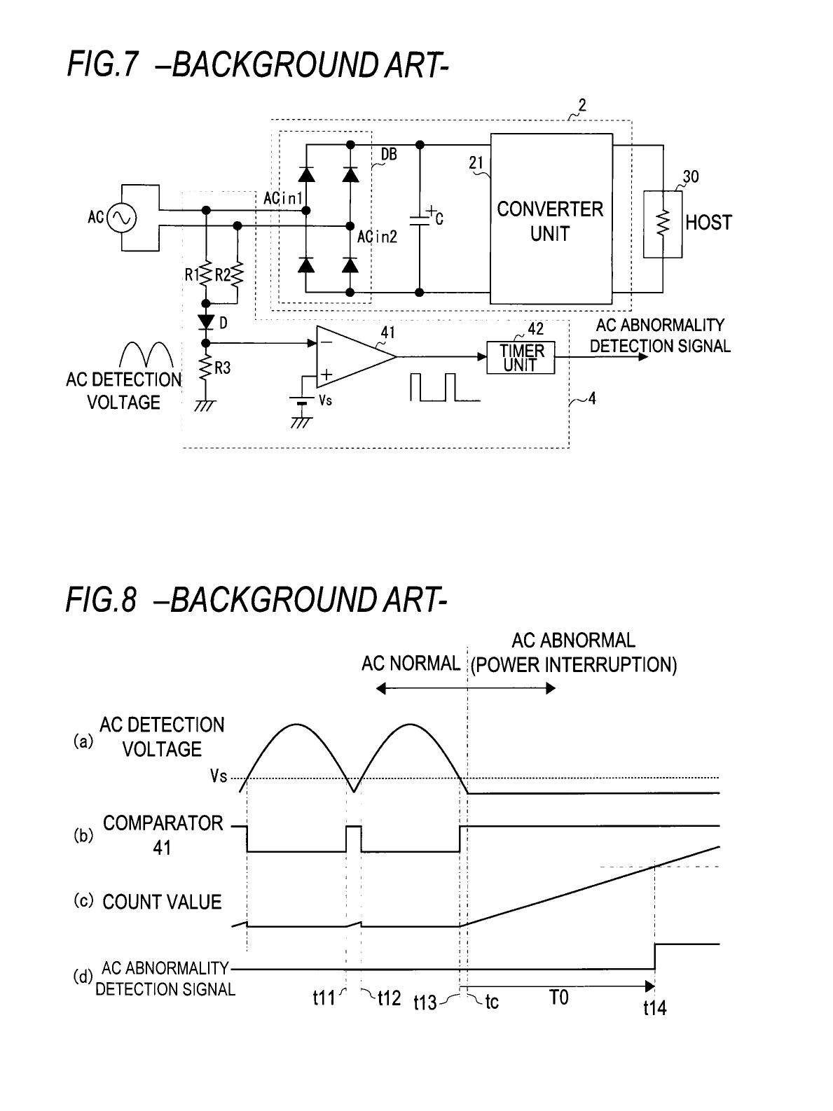

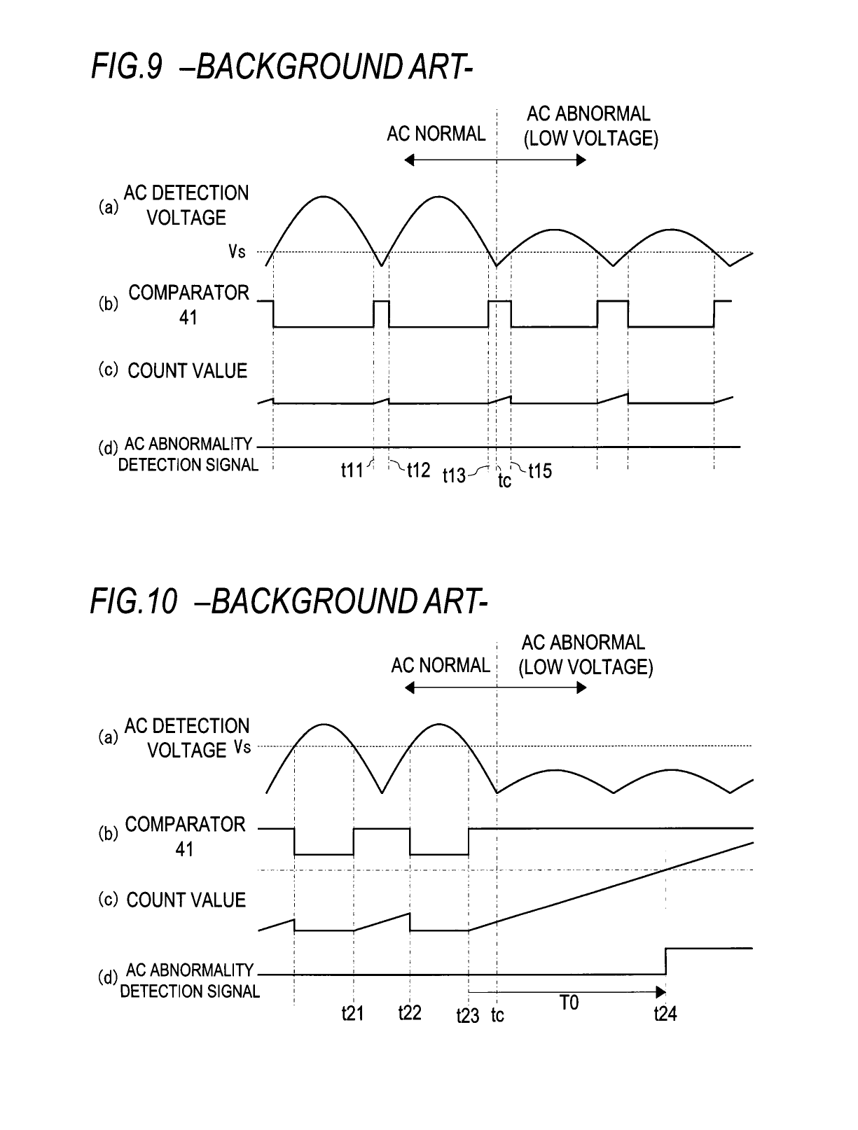

As shown in FIG. 5A, a DC voltage V0 of an AC/DC power source according to the background art is gradually fallen when a holding time T1 is terminated after a power interruption. In the voltage waveform of the DC voltage V0, a point (inflection point) at which the gradient is changed may be occurred. Also, the DC voltage V0 may be momentarily risen. Due to the inflection point of the DC voltage, the host 30 is possibly adversely affected. The cause that of inflection point is varied depending upon a circuit configuration, a control method, a load situation or the like of the AC/DC power source 40, but it is caused by the continuation of controlling of AC/DC power source 40 even after the holding time T1 is terminated.

Herein, as this disclosure using the AC abnormality detection signal outputted from the AC input voltage detection circuit 1, the AC/DC power source 40 stops power control before the holding time T1 is terminated, or stops outputting of the DC voltage V0 before the holding time T1 is terminated, as shown in FIG. 5B. In other words, the AC/DC power source 40 uses the AC abnormality detection signal outputted from the AC input voltage detection circuit 1 as a timing for stopping the control by itself. In addition, if the occurrence timing of ‘abnormality (a power interruption or a low voltage)’ of the AC input voltage cannot be time-measured at a high accuracy, it happens that the holding time T1 is exceeded or the power control is stopped without sufficiently keeping the holding time T1. Contrarily, the AC abnormality detection signal outputted from the AC input voltage detection circuit 1 is outputted from the AC input voltage detection circuit 1 after the abnormality detection time T0 has been passed from the occurrence timing of ‘abnormality (a power interruption or a low voltage)’ of the AC input voltage time-measured at a high accuracy. Therefore, the AC/DC power source 40 can be sufficiently keep the holding time T1 without exceeding the required holding time.

As described above, according to the present embodiment, an AC input voltage detection circuit I detecting abnormality of an AC input voltage inputted to an AC/DC converter 2 includes, a comparator 11 (a first comparator circuit) comparing an AC detection voltage (the AC input voltage) with a reference voltage VsL (a first reference voltage); a comparator 12 (a second comparator circuit) comparing the AC detection voltage with a reference voltage VsH (a second reference voltage) higher than the reference voltage VsL; and a timer unit 13 starting counting of a timer if the comparator 11 detects that, the AC detection voltage is equal to or lower than the reference voltage VsL, and clearing the counting of the timer if the comparator 12 detects that the AC detection voltage is higher than the reference voltage VsH, wherein the timer unit 13 outputs an AC abnormality detection signal when a preset abnormality detection time T0 is passed without clearing the counting since the counting of the timer has been started. According to this configuration, even if abnormality occurred in an AC power source AC is either of a power interruption or a low voltage, the counting of the timer can be started based on the reference voltage VsL lower than the reference voltage VsH, and a time, at which the AC input voltage becomes abnormal, can be accurately measured. Also, two reference voltages VsL and VsH are used to control the single timer unit 13. Therefore, the time, at which the AC input voltage becomes abnormal, can be accurately measured even if abnormality is either of a power interruption or a low voltage.

Also, according to the present embodiment, the reference voltage VsL is a threshold voltage for detecting whether the AC input voltage is interrupted or not, and is set to be equal to or lower than a peak value of a low voltage, which is detected as abnormality, and the reference voltage VsH is a threshold voltage for detecting whether the AC input voltage is a low voltage or not, and is set to a value larger than the peak value of the low voltage, which is detected as abnormality. By these configurations, the time, at which the AC input voltage becomes abnormal, can be more accurately measured even if abnormality occurred in the alternating current power source AC is either of a power interruption or a low voltage.

In addition, according to the present embodiment, the abnormality detection time T0 is set to a time period shorter than a value obtained by subtracting a termination process time T2 in a host 30, to which the AC/DC converter 2 supplies a DC voltage, from a holding time T11 of the AC/DC converter 2. By this configuration, it is possible to ensure the termination process time T2 in the host 30.

In the foregoing, although this disclosure has been described with reference to specific embodiments thereof, it will be appreciated that the embodiments are only illustrative, and accordingly, various modifications thereof may be made without departing from the scope and spirit of this disclosure.

What is claimed is:

1. An AC input voltage detection circuit of detecting abnormality of an AC input voltage inputted to an AC/DC converter, comprising:
a first comparator circuit configured to compare the AC input voltage with a first reference voltage;
a second comparator circuit configured to compare the AC detection voltage with a second reference voltage higher than the first reference voltage; and
a timer circuit configured to start counting of a timer if the first comparator circuit detects that the AC input voltage is equal to or lower than the first reference voltage and to clear the counting of the timer if the second comparator detects that the AC input voltage is larger than the second reference voltage, wherein the timer circuit outputs an AC abnormality detection signal when a preset abnormality detection time is passed without clearing the counting since the counting of the timer has been started.

2. The AC input voltage detection circuit according to claim 1,
wherein the first reference voltage is set to be equal to or lower than a peak value of a low voltage, which is detected as abnormality, and
wherein the second reference voltage is set to be larger than the peak value of the low voltage, which is detected as abnormality.

3. The AC input voltage detection circuit according to claim 1,
wherein the first reference voltage is a threshold voltage for detecting whether the AC input voltage is interrupted or not, and
wherein the second reference voltage is a threshold voltage for detecting whether the AC input voltage is a low voltage or not.

4. The AC input voltage detection circuit according to claim 1,
wherein the abnormality detection time is set to a time period shorter than a time obtained by subtracting a termination process time in a load, to which the AC/DC converter supplies a DC voltage, from a holding time of the AC/DC converter.

5. An AC/DC power source comprising an AC input voltage detection circuit of detecting abnormality of an AC input voltage inputted to an AC/DC converter, the AC input voltage detection circuit comprising:
a first comparator circuit configured to compare the AC input voltage with a first reference voltage;
a second comparator circuit configured to compare the AC detection voltage with a second reference voltage higher than the first reference voltage; and
a timer circuit configured to start counting of a timer if the first comparator circuit detects that the AC input voltage is equal to or lower than the first reference voltage and to clear the counting of the timer if the second comparator detects that the AC input voltage is larger than the second reference voltage, wherein the timer circuit outputs an AC abnormality detection signal when a preset abnormality detection time is passed without clearing the counting since the counting of the timer has been started.
